(19) United States
(12) Patent Application Publication
(10) Pub. No.: US 2025/0391888 A1
(43) Pub. Date: Dec. 25, 2025

(54) MULTI-PIECE DATUM RAIL

(71) Applicant: GM Global Technology Operations LLC, Detroit, MI (US)

(72) Inventors: Venkata Kommisetti, Rochester Hills, MI (US); Oscar Milan Garcia, Lake Orion, MI (US); Ronald Miller, Bloomfield Hills, MI (US)

(21) Appl. No.: 18/749,022

(22) Filed: Jun. 20, 2024

(51) Int. Cl. H01M 8/0247; H01M 8/247

(52) U.S. Cl. CPC H01M 8/0247; H01M 8/247; H01M 2250/20

(57) ABSTRACT

A fuel cell system includes end covers, beam-like datum rails extending from one end cover to an opposite end cover and engaging in interference fit with the end covers. Bipolar plates (BPPs) are stacked between the end covers. The BPPs have locating features sized and shaped to slidingly engage with the datum rails. The datum rails align the BPPs with corresponding electrical, fluid, and mechanical features formed in the end covers. Each datum rail includes two or more modular datum rail portions having locating pin receivers formed axially in ends thereof. Locating pins are disposed within the receivers. Each rail portion is connected to at least one other rail portion via the plurality of locating pins. At least one rail portion is connected to each end cover, and to at least one other rail portion via locating pins.

### INTRODUCTION

The present disclosure relates to an improved design for assembling a fuel cell stack, as well as to secure and maintain the relative position of fuel cells within the stack under normal use, as well as during and after exposure to impacts and other high acceleration loads.

Uniform cell assembly, including bipolar plates (BPPs), uniform cell assembly (CEA), and sub gaskets in fuel cells is vital in order to ensure cell alignment. As cell sizes increase and are used in larger quantities in a fuel cell assembly, the orientation and uniform assembly of each of the cells becomes more complicated. Datum rails are used to maintain cell alignment in the stack during assembly. The datum rails are often retained in a housing at the end of assembly as well. Datum rails are also often long and narrow, and tight tolerances in the cells, and in the fuel cell stack can increase the complexity of assembly procedures as a result.

Accordingly, while current systems and methods for assembling fuel cell stacks achieve their intended purpose, there is a need for a new and improved system and method for assembly of fuel cell stacks that utilize a datum rail that electrically insulates the BPPs from metal casings of the fuel cell while providing simplified assembly, maintaining tight tolerances, and providing sufficient structural rigidity to ensure that the BPPs, CEA and sub gaskets all maintain correct cell alignment, without increasing overall fuel cell complexity, and providing a modular and portable solution for fuel cell stack assembly in a variety of scenarios.

### SUMMARY

According to several aspects a fuel cell system includes a first end cover, a second end cover, and two or more linear beam-like datum rails extending from the first end cover to the second end cover and engaging in interference fit with the first end cover and with the second end cover. The fuel cell system further includes at least one bipolar plate (BPP). The at least one bipolar plate has locating features formed therein. The locating features are sized and shaped to enter into sliding engagement with the two or more linear beam-like datum rails. The two or more beam-like datum rails align the at least one bipolar plate with corresponding electrical, fluid, and mechanical features formed in the first end cover and the second end cover. Each of the two or more datum rails includes: two or more modular datum rail portions. Each of the two or more modular datum rail portions extends from a first rail portion end to a second rail portion end. A plurality of locating pin receivers is formed axially in each of the first and second rail portion ends. A plurality of locating pins are disposed within the plurality of locating pin receivers. Each subsequent datum rail portion is connected to at least one other datum rail portion via the plurality of locating pins. At least one datum rail portion is connected to the first end cover via locating pins and at least one rail other datum rail portion is connected to the second end cover and to the datum rail portion connected to the first end cover via locating pins.

In another aspect of the present disclosure the each of the plurality of locating pins is formed of austenitic steel and expandable from a first diameter to a second diameter larger than the first. Each of the plurality of locating pins has a substantially cylindrical overall shape, and the locating pins having a centering portion at terminal ends of the substantially cylindrical overall shape. The centering portion tapers to a diameter smaller than a diameter of the locating pin receivers.

In another aspect of the present disclosure the first diameter is smaller than a diameter of the locating pin receivers, and the second diameter is greater than the diameter of the locating pin receivers, and upon insertion into the locating pin receivers, each of the plurality of locating pins engages in an interference fit with the locating pin receivers.

In another aspect of the present disclosure approximately fifty percent (50%) of each of the plurality of locating pins that attaches one of the datum rail portions to another of the datum rail portions is disposed in each of the datum rail portions.

In another aspect of the present disclosure approximately sixty percent (60%) of each of the plurality of locating pins that attaches one of the datum rail portions to the first end cover or to the second end cover is disposed in the datum rail portion, whereas approximately forty percent (40%) of the locating pin is disposed within end cover receivers formed in the first and second end covers.

In another aspect of the present disclosure the locating pins extend for at total length of approximately twenty-four millimeters, and the locating pins are inserted approximately twelve millimeters into locating pin receivers formed in datum rail portions connected to other datum rail portions. The locating pin receivers extend for approximately thirteen millimeters in datum rail portions connected to other datum rail portions.

In another aspect of the present disclosure the locating pins extend for at total length of approximately twenty-four millimeters, and the locating pins are inserted approximately fifteen millimeters into locating pin receivers formed in datum rail portions connected to the first or second end covers. The locating pins are inserted approximately nine millimeters into the end cover receivers, and the locating pin receivers extend for approximately sixteen millimeters in datum rail portions connected the first or second end covers and the end cover receivers extend for approximately ten millimeters.

In another aspect of the present disclosure the datum rail portions have a substantially C-shaped or U-shaped cross-sectional profile that is consistent over an entire length of the datum rail portions, and over an entire length of the datum rail. Locating features of each BPP define C-shaped or U-shaped axial openings located circumferentially about each BPP to receive and enter into close axial sliding engagement with the substantially C-shaped or U-shaped cross-sectional datum rail portions.

In another aspect of the present disclosure each of the datum rail portions are pultrusion formed of material having a flexural modulus of at least 10 Gpa, tensile strength in all directions of at least 280 Mpa, and volume resistivity of greater than or equal to 1.00e+14 ohm-cm.

In another aspect of the present disclosure each of the two or more linear beam-like datum rails has: a tensile-axial force capability in a Y-direction of at least 46.5 kN, a transverse force capability in a X-direction of at least 46.5 kN; and a transverse force capability in a Z-direction of at least 46.5 kN.

In another aspect of the present disclosure the first end cover is a dry end cover and the second end cover is a wet end cover. The wet end cover has fluid passageways formed therethrough. The fluid passageways are in fluid communication with one or more BPP of a stack of BPPs disposed between the first end cover and the second end cover.

In another aspect of the present disclosure a fuel cell system includes a wet end cover, a dry end cover, and a plurality of rigid, linear, beam-like datum rails extending from the wet end cover to the dry end cover and engaging in interference fit with the wet end cover and the dry end cover. The datum rails have substantially c-shaped or u-shaped cross-sectional profiles that are consistent over an entire length of the datum rails. The fuel cell system further includes a plurality of bipolar plates (BPPs) sandwiched between the wet end cover and the dry end cover. Each of the plurality of BPPs has locating features formed therein. The locating features are sized and shaped to enter into sliding engagement with plurality of datum rails such that the plurality of datum rails align the plurality of BPPs with corresponding electrical, fluid, and mechanical features of neighboring BPPs and with the wet end cover and the dry end cover. Each of the plurality of datum rails includes: a plurality of modular datum rail portions, each extending from a first datum rail portion end to a second datum rail portion end. Each of the plurality of datum rails further includes a plurality of locating pin receivers is formed axially in each of the first and second datum rail portion ends; and a plurality of locating pins are disposed within the plurality of locating pin receivers.

In another aspect of the present disclosure each subsequent datum rail portion is connected to at least one other datum rail portion via the plurality of locating pins. At least one datum rail portion is connected to the wet end cover via locating pins and at least one other datum rail portion is connected to the dry end cover via locating pins. At least one datum rail portion connects the datum rail portion connected the wet end cover to the datum rail portion connected to the dry end cover via locating pins.

In another aspect of the present disclosure each of the plurality of locating pins is formed of austenitic steel and is expandable from a first diameter to a second diameter larger than the first. Each of the plurality of locating pins has a substantially cylindrical overall shape. The locating pins having a centering portion at terminal ends of the substantially cylindrical overall shape. The centering portion tapers to a diameter smaller than a diameter of the locating pin receivers. The first diameter is smaller than a diameter of the locating pin receivers, and the second diameter is greater than the diameter of the locating pin receivers. Upon insertion into the locating pin receivers, each of the plurality of locating pins engages in an interference fit with the locating pin receivers.

In another aspect of the present disclosure approximately fifty percent (50%) of each of the plurality of locating pins that attaches one of the datum rail portions to another of the datum rail portions is disposed in each of the datum rail portions. Approximately sixty percent (60%) of each of the plurality of locating pins that attaches one of the datum rail portions to the wet end cover or to the dry end cover is disposed in the datum rail portion, whereas approximately forty percent (40%) of the locating pin is disposed within end cover receivers formed in the wet and dry end covers.

In another aspect of the present disclosure the locating pins extend for at total length of approximately twenty-four millimeters. The locating pins are inserted approximately twelve millimeters into locating pin receivers formed in datum rail portions connected to other datum rail portions. The locating pin receivers extend for approximately thirteen millimeters in datum rail portions connected to other datum rail portions. The locating pins are inserted approximately fifteen millimeters into locating pin receivers formed in datum rail portions connected to the wet or dry end covers. The locating pins are inserted approximately nine millimeters into the end cover receivers. The locating pin receivers extend for approximately sixteen millimeters in datum rail portions connected the wet or dry end covers and the end cover receivers extend for approximately ten millimeters.

In another aspect of the present disclosure locating features of each of the plurality of BPPs define C-shaped or U-shaped axial openings located circumferentially about each of the plurality of BPPs to receive and enter into close axial sliding engagement with the substantially C-shaped or U-shaped cross-sectional datum rail portions.

In another aspect of the present disclosure each of the datum rail portions are pultrusion formed of material having a flexural modulus of at least 10 Gpa, tensile strength in all directions of at least 280 Mpa, and volume resistivity of greater than or equal to 1.00e+14 ohm-cm.

In another aspect of the present disclosure each of the plurality of datum rails has: a tensile-axial force capability in a Y-direction of at least 46.5 kN; a transverse force capability in a X-direction of at least 46.5 kN; and a transverse force capability in a Z-direction of at least 46.5 kN.

In another aspect of the present disclosure, a fuel cell system includes a wet end cover, a dry end cover, and a plurality of rigid, linear, beam-like datum rails extending from the wet end cover to the dry end cover and engaging in interference fit with the wet end cover and the dry end cover. The datum rails have substantially c-shaped or u-shaped cross-sectional profiles that are consistent over an entire length of the datum rails. The fuel cell system further includes a plurality of bipolar plates (BPPs) sandwiched between the wet end cover and the dry end cover. Each of the plurality of BPPs includes locating features formed therein. The locating features are sized and shaped to enter into sliding engagement with plurality of datum rails such that the plurality of datum rails align the plurality of BPPs with corresponding electrical, fluid, and mechanical features of neighboring BPPs and with the wet end cover and the dry end cover. Each of the plurality of datum rails includes: a plurality of modular datum rail portions, each extending from a first datum rail portion end to a datum second rail portion end. Each of the plurality of datum rails further includes a plurality of locating pin receivers is formed axially in each of the first and second datum rail portion ends. A plurality of locating pins are disposed within the plurality of locating pin receivers. Each subsequent datum rail portion is connected to at least one other datum rail portion via the plurality of locating pins. At least one datum rail portion is connected to the wet end cover via locating pins and at least one other datum rail portion is connected to the dry end cover via locating pins; and wherein at least one datum rail portion connects the datum rail portion connected to the wet end cover to the datum rail portion connected to the dry end cover via locating pins. Each of the plurality of locating pins is formed of austenitic steel and expandable from a first diameter to a second diameter larger than the first. Each of the plurality of locating pins has a substantially cylindrical overall shape. The locating pins having a centering portion at terminal ends of the substantially cylindrical overall shape. The centering portion tapers to a diameter smaller than a diameter of the locating pin receivers. The first diameter is smaller than a diameter of the locating pin receivers, and the second diameter is greater than the diameter of the locating pin receivers, and upon insertion into the locating pin receivers, each of the plurality of locating pins engages in an interference fit with the locating pin receivers. Approximately fifty percent (50%) of each of the plurality of locating pins that attaches one of the datum rail portions to another of the datum rail portions is disposed in each of the datum rail portions. Approximately sixty percent (60%) of each of the plurality of locating pins that attaches one of the datum rail portions to the wet end cover or to the dry end cover is disposed in the datum rail portion, whereas approximately forty percent (40%) of the locating pin is disposed within end cover receivers formed in the wet and dry end covers. The locating pins extend for at total length of approximately twenty-four millimeters, and the locating pins are inserted approximately twelve millimeters into locating pin receivers formed in datum rail portions connected to other datum rail portions. The locating pin receivers extend for approximately thirteen millimeters in datum rail portions connected to other datum rail portions. The locating pins are inserted approximately fifteen millimeters into locating pin receivers formed in datum rail portions connected to the wet or dry end covers, and the locating pins are inserted approximately nine millimeters into the end cover receivers. The locating pin receivers extend for approximately sixteen millimeters in datum rail portions connected the wet or dry end covers and the end cover receivers extend for approximately ten millimeters. Locating features of each of the plurality of BPPs define C-shaped or U-shaped axial openings located circumferentially about each of the plurality of BPPs to receive and enter into close axial sliding engagement with the substantially C-shaped or U-shaped cross-sectional datum rail portions. Each of the datum rail portions are pultrusion formed of material having a flexural modulus of at least 10 Gpa, tensile strength in all directions of at least 280 Mpa, and volume resistivity of greater than or equal to 1.00e+14 ohm-cm. Each of the plurality of datum rails has: a tensile-axial force capability in a Y-direction of at least 46.5 kN; a transverse force capability in a X-direction of at least 46.5 kN; and a transverse force capability in a Z-direction of at least 46.5 kN.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including a fuel cell system having a fuel cell assembly with a multi-piece datum rail according to an exemplary embodiment;

FIG. 2A is a schematic partial isometric view of a portion of the fuel cell system of FIG. 1 depicting end plates and datum rails of the fuel cell assembly without bipolar plates in further detail according to an exemplary embodiment;

FIG. 2B is a schematic partial isometric view of a portion of the fuel cell system of FIG. 1 depicting datum rails aligning a bipolar plate of the fuel cell assembly according to an exemplary embodiment;

FIG. 3A is a schematic partial isometric view of a fully-assembled multi-piece datum rail according to an exemplary embodiment;

FIG. 3B is a schematic partial isometric exploded view of the multi-piece datum rail of FIG. 3A according to an exemplary embodiment;

FIG. 3C is a partial cross-sectional view of the multi-piece datum rail of FIG. 3A according to an exemplary embodiment;

FIG. 4A is a schematic partial cross-sectional view of the assembled datum rail of FIG. 3A depicting a locating pin and pin receivers according to an exemplary embodiment;

FIG. 4B is a schematic diagram of a cross-sectional view of the locating pin of FIG. 4A according to an exemplary embodiment; and

FIG. 4C is a schematic side view of the locating pin of FIG. 4A according to an exemplary embodiment.

### DETAILED DESCRIPTION

The following description is merely exemplary in nature and is not intended to limit the present disclosure, application, or uses.

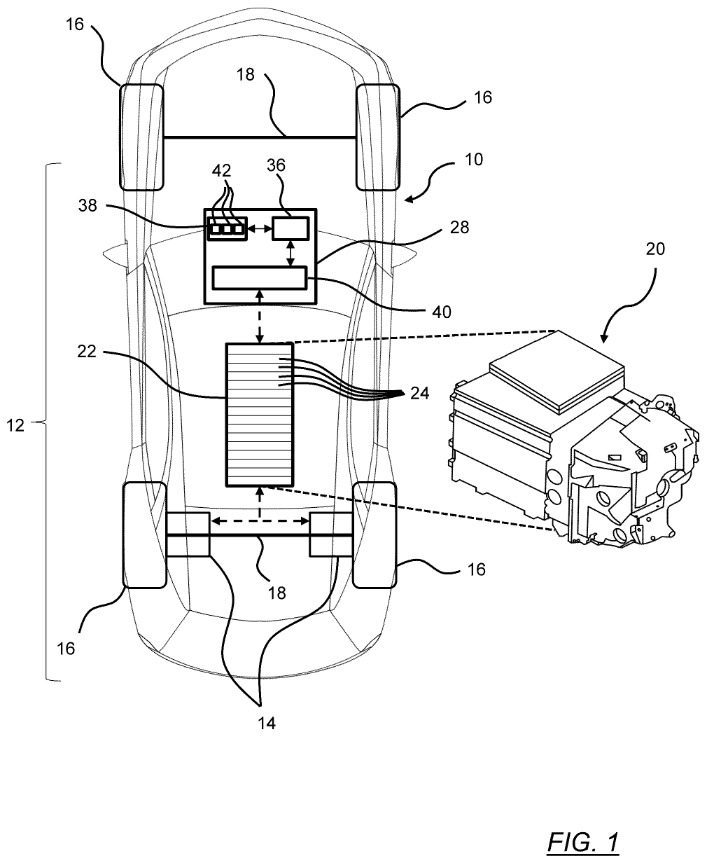

Referring to FIG. 1, vehicle 10 having a fuel cell-based propulsion system 12 is shown. While the vehicle 10 shown is a passenger vehicle, it should be appreciated that the vehicle 10 may be any of a wide variety of types of vehicle 10 without departing from the scope or intent of the present disclosure. In several examples, the vehicle 10 may be a car, a van, a bus, a semi, a tractor, an off-road vehicle, an aircraft such as a plane or a helicopter, watercraft, or the like. The fuel cell-based propulsion system 12 includes at least a drive motor 14 motivated by energy obtained via a fuel cell assembly 20. It should be appreciated that the vehicle 10 may be motivated by one or more drive motors 14 without limitation. That is, in some examples, the vehicle 10 may have a single drive motor 14 capable of moving the wheels 16 of the vehicle 10, and thereby causing the vehicle 10 to move. In other examples, the vehicle 10 may be equipped with a plurality of drive motors 14, such as one drive motor 14 for each wheel 16, or one drive motor 14 for each axle 18 of the vehicle. In vehicles 10 equipped with fuel cell-based propulsion systems 12, the drive motors 14 are electric motors, and the fuel-cell based propulsion system 12 is configured to generate electricity from hydrogen or other fuels stored onboard the vehicle 10. It will be appreciated that while FIG. 1 includes only a depiction of one fuel cell assembly 20, the fuel-cell-based propulsion system 12 may include any number of fuel cell assemblies 20 without departing from the scope or intent of the present disclosure.

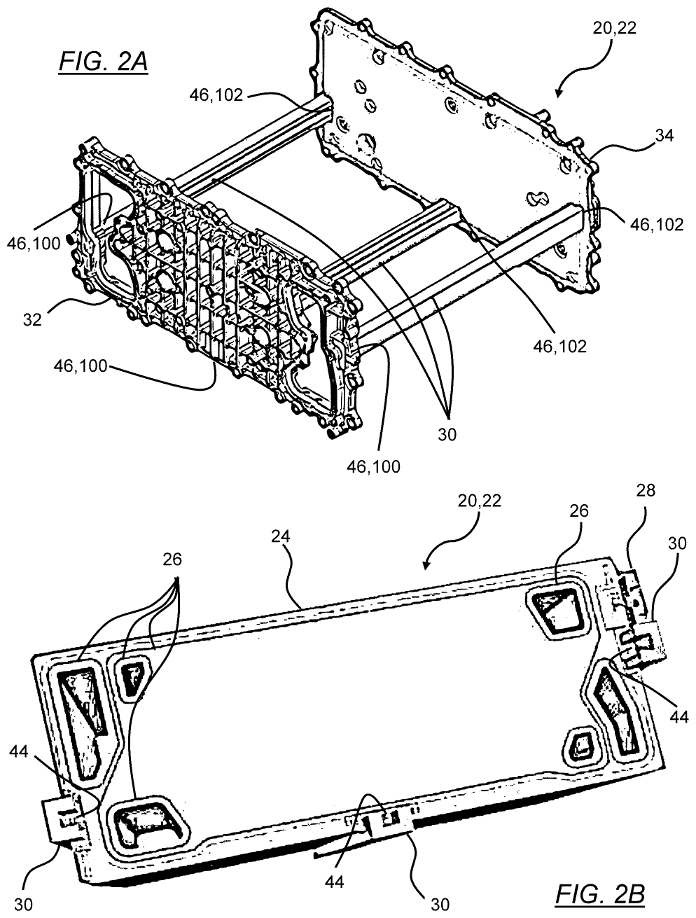

Turning now to FIGS. 2A and 2B and with continuing reference to FIG. 1, the fuel cell assembly 20 is shown in further detail. The fuel cell assembly 20 includes a fuel cell stack 22 formed of a series of bipolar plates (BPPs) 24 having sub-gaskets 26, and controllers 28. The BPPs 24 are placed adjacent to and in contact with one another to form the fuel cell stack 22. To ensure that the fuel cell stack 22 operates properly, each of the BPPs 24 is aligned with the other BPPs 24 in the stack with one or more datum rails 30. The datum rails 30 are substantially rigid bar-like structures that extend from a wet end cover 32 to a dry end cover 34 of the fuel cell assembly 20. The wet end cover 32 has one or more fluid passageways formed therethrough. The fluid passageways are in fluid communication with one or more of the BPPs 24 of the fuel cell stack 22. By contrast, the dry end cover 34 defines an exterior surface of the fuel cell assembly 20 and does not have passageways for fluid communication formed through it. In several aspects, the BPPs 24 are sandwiched between the wet end cover 32 and the dry end cover 34 and aligned with one another and the wet and dry end covers 32, 34 via the datum rails 30.

The BPPs 24 provide proton exchange membrane, alkaline and solid oxide fuel cells, and electrolysers. BPPs 24 are machined with complex flow fields or channels that, when stacked, distribute gas and air, as well as conducting electrical current from one cell to the next cell. In several aspects, the stacking of the BPPs 24 within the fuel cell stack 22 of the present disclosure causes uniform application of a force that seals individual BPPs 24 against one another and contributes to low electrical contact resistance at each interface of each component of each BPP 24 of the fuel cell stack 22.

The controllers 28 are non-generalized, electronic control devices having a preprogrammed digital computer or processor 36, non-transitory computer readable medium or memory 38 used to store data such as control logic, software applications, instructions, computer code, data, lookup tables, etc, and a transceiver or input/output (I/O) ports 40. Computer readable medium or memory 38 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium or memory 38 excludes wired, wireless, optical, or other communication links that transport transitory electrical or other signals. A non-transitory computer readable medium or memory 38 includes media where data can be permanently stored and media where data can be stored and later overwritten, such as a rewritable optical disc or an erasable memory device. Computer code includes any type of program code, including source code, object code, and executable code. The processor 36 is configured to execute the code or instructions. Where the client 10 is a motor vehicle 10, the controller 28 may be a dedicated Wi-Fi controller or an engine control module, a transmission control module, a body control module, an infotainment control module, or a fuel cell propulsion system 12 controller, etc.

The controllers 28 may store and execute one or more applications 42. An application 42 is a software program configured to perform a specific function or set of functions. The application 42 may include one or more computer programs, software components, sets of instructions, procedures, functions, objects, classes, instances, related data, or a portion thereof adapted for implementation in a suitable computer readable program code. The applications 42 may be stored within the memory 38 or in additional or separate memory. Examples of the applications 42 include audio or video streaming services, games, browsers, social media, body control applications, transmission control programs, engine management programs, or fuel propulsion system 12 management programs that manage power generation and output from fuel cell assemblies 20 to the drive motors 14 of the vehicle 10.

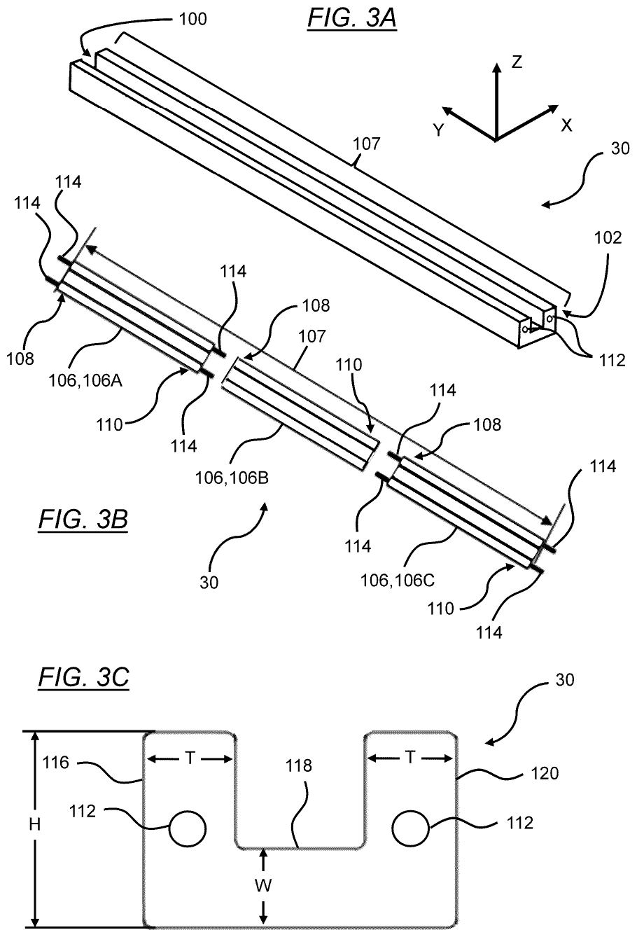

Referring now to FIG. 3A, 3B, and 3C, and with continued reference to FIGS. 1, 2A and 2B, an exemplary datum rail 30 is shown in further detail. The datum rails 30 ensure the cells or BPPs 24 in the fuel cell stack 22 are properly aligned and compressed against neighboring cells in the fuel cell stack 22. Datum rails 30 are structural members that mechanically interact with locating features 44 formed in each of the BPPs 24 in the fuel cell stack 22, as well as end cover receivers 46 formed in each of the wet end cover 32 and the dry end cover 34. More specifically, the datum rails 30 are received within the end cover receivers 46 formed in the wet and dry end covers 32, 34 respectively. The end cover receivers 46 may take a variety of different forms, including securing features such as, but not limited to: screws, bolts, clamps, clips, interference fittings, dowel pins and receivers for dowel pins, and the like. In further examples, the end cover receivers 46 are shaped and sized to directly receive and accept the datum rails 30 with features that correspond to cross sectional profiles of the datum rails 30. Likewise, the locating features 44 formed in each of the BPPs 24 of the fuel cell stack 22 may take any of a variety of shapes, sizes, and forms that correspond to and lockingly interact with the datum rails 30. In the non-limiting examples depicted in FIGS. 3A, 3B, and 3C, specifically, the datum rail 30 defines an elongate bar having a substantially u-shaped or c-shaped cross-sectional profile that is consistent over the entirety of the datum rail 30. In several further examples, the cross-sectional profile of the datum rail 30 may have an L-shape, a V or A shape, an S-shape, a semi-circular shape, or any of a variety of other shapes without departing from the scope or intent of the present disclosure. Accordingly, the locating features 44 formed through the BPPs 24 are located circumferentially about the BPPs 24 at locations corresponding to locations of the datum rails 30 extending from the wet end cover 32 to the dry end cover 34. In examples where the datum rails 30 have substantially c-shaped or u-shaped cross-sectional profiles, the locating features 44 define substantially c-shaped or u-shaped openings corresponding to and sized and shaped precisely to enter into close axial sliding engagement with the datum rails 30.

The datum rail 30 extends from a first end 100 to a second end 102, where the first end 100 contacts and is received within the end cover receiver 46 formed in the wet end cover 32 and the second end 102 contacts and is received within the end cover receiver 46 formed in the dry end cover 34. In order to properly, securely, and precisely locate the BPPs 44 of the fuel cell stack 22 during assembly of the fuel stack 22, the datum rails 30 are assembled with the BPPs 44 by sliding the datum rails 30 into the locating features 44 formed in each of the BPPs 24. Put another way, the datum rails 30 are aligned with the locating features 44 of the BPPs 24, and additional BPPs 24 are sequentially stacked upon preceding BPPs 44 in an orientation that corresponds with the locating features 44 of each previous BPP 24 in the fuel stack 22. Accordingly, the datum rails 30 provide for and enforce alignment of the BPPs 24 relative to one another, thereby ensuring accurate and precise alignment of the BPPs 24 in the fuel stack 22. However, tolerances within the locating features 44 of the BPPs 24 are extremely tight in relation to the size and shape of the datum rails 30. Accordingly, linearly sliding the BPPs 24 onto the datum rails 30, or sliding the datum rails 30 into the BPPs 24, may be time, resource, and frictionally challenging. Accordingly, the datum rail 30 of the present disclosure is modular so that a given BPP 24 may only be required to traverse a portion 104 of the datum rail 30 during assembly of the fuel stack 22, rather than being required to slide along the entirety of the datum rail 30, even if the BPP 24 is the first BPP 24 in the fuel stack 22.

In several examples, the datum rail 30 includes at least one, and preferably at least two datum rail portions 106A, 106B, but may include larger quantities of datum rail portions 106 without departing from the scope or intent of the present disclosure. In the example shown in FIGS. 3A, 3B, and 3C, the datum rail 30 includes three datum rail portions 106A, 106B, and 106C. Each of the datum rail portions 106 define identical cross-sections as the other datum rail portions 106. That is, each of the datum rail portions 106 defines a substantially linear beam-like structure extending from a first rail portion end 108 to a second rail portion end 110. Each of the first and second rail portion ends 108, 110 includes one or more locating pin receivers 112. The locating pin receivers 112 extend longitudinally into the first and second rail portion ends 108, 110. The locating pin receivers 112 are sized and shaped to accept locating pins 114 in a spring-loaded interference-fit.

In FIG. 3C, an exemplary, non-limiting datum rail 30 is shown in cross-sectional view. The cross-section of the exemplary datum rail 30 defines a substantially u-shape or c-shape. The u-shape or c-shape includes a first leg 116 connected to a base portion 118, and a second leg 120 connected to the base portion 118 opposite, spaced apart from, and parallel to the first leg 116. As shown in FIG. 3C, the first and second legs 116, 120 may extend perpendicular to the base portion 118. In other examples, the first and second legs 116, 120, may be connected to the base portion 118 at an angle other than ninety degrees (90°) without departing from the scope or intent of the present disclosure. In some examples in which the first and second legs 116, 120 are attached at non-orthogonal angles to the base portion 118, the first and second legs 116, 120 may also not be parallel to one another. That is, the first and second legs 116, 120 may form a flared or widened V-shape or U-shape, where the base portion 118 is connected to the first and second legs 116, 120 at an obtuse angle between about one-hundred degrees (100°) and about one-hundred sixty degrees (160°), or at approximately one-hundred twenty degrees (120°), or other such angles without departing from the scope or intent of the present disclosure. Heights “H” of the first and second legs 116, 120, a width “W” of the base portion 118, and thicknesses “T” of the first and second legs 116, 120 and base portion 118 are chosen to provide predetermined rigidity to the datum rail 30 as will be discussed in further detail below.

The structural qualities of the datum rail 30 are defined at least in part by functional demands, as well as achieving material quality goals for sustainability, recyclability, and recoverability, while maintaining at least V-1 flammability goals established under IEC 60695-11-10, UL94, or other equivalent testing methodologies. The structural qualities are defined by longitudinal and transverse force applications. In several examples, the datum rail 30 is formed of a non-conductive material having tensile-axial force capabilities in the Y-direction in the 46.5 kN range with a safety factor of at least 7.5, and a transverse force in the X-direction capability in the 46.5 kN range with a safety factor of at least 3, and a transverse force in the Z-direction of 46.5 kN with a safety factor of at least 4. The materials used for the datum rail 30 should also provide a flexural modulus of at least 10 Gpa, and a tensile strength in all directions of at least 280 Mpa, while maintaining a volume resistivity of greater than or equal to 1.00e+14 ohm-cm.

The datum rail 30, and more specifically rail portions 106 are formed through pultrusion processes that decrease profile variations along the datum rail portions 106. More specifically, pultrusion enables continuous production via a heated die that gives shape to the datum rail portions 106 and provides excellent control over the cross-sectional shape and dimensions of the cross-sectional shape of the datum rail portions 106. By minimizing variation along the length 107 of the datum rail 30, including individual rail portions 106, such as first, second and third rail portions 106A, 106B, 106C, accurate and precise location alignment of the BPPs 24, the wet end cover 32 and the dry end cover 34 is ensured during assembly of the fuel cell stack 22. By ensuring the alignment and location of the BPPs 24 relative to one another and to the wet end cover 32 and the dry end cover 34, both fluid seals and electrical connectivity is assured, improving manufacturing efficiency, decreasing time required to adjust BPP 24 alignment in the fuel cell stack 22, and improving fuel cell propulsion system 12 operating efficiency in the vehicle 10 as well. Furthermore, by decreasing cross-sectional shape variation along the length 107 of the datum rails 30 relative to other manufacturing methods such as pure extrusion, casting, or the like, each BPP 24 is more easily slidable along the datum rails 30 despite very tight tolerances between the datum rails 30 and the locating features 44 formed in each of the BPPs 24.

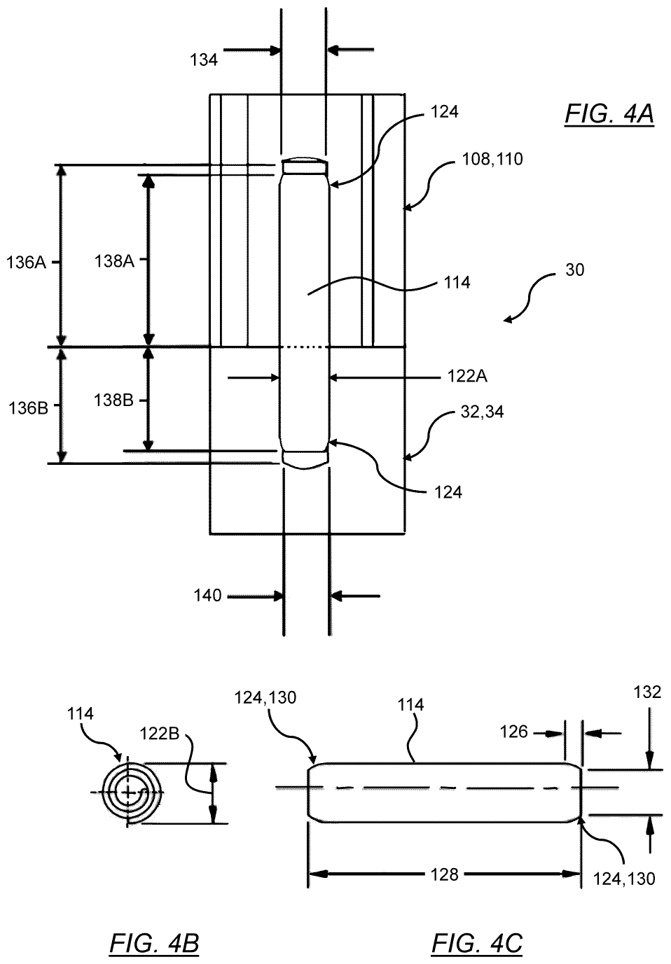

Turning now to FIGS. 4A, 4B, and 4C and with continued reference to FIGS. 1, 2A, 2B, 3A, 3B, and 3C, the locating pin receivers 112 and locating pins 114 are shown in further detail.

FIG. 4A depicts the assembly of the datum rail 30 with the wet and dry end covers 32, 34. During assembly of a first rail portion 106A with the dry end cover 34 of the fuel cell assembly 20, a locating pin 114 is first inserted into the locating pin receiver 112 formed in the first rail portion end 108 of the first rail portion 106A. The locating pin 114 is inserted in a spring-loaded interference fit so that approximately sixty percent (60%) of the locating pin 114 is inserted into and disposed within the locating pin receiver 112 formed in the first rail portion end 108 of the first rail portion 106A. The end cover receivers 46 in the dry end cover 34 further include locating pin receivers. The first rail portion end 108 is subsequently aligned with and assembled so that the end cover receivers 46 formed in the dry end cover 34 may accurately and precisely engage into an interference fit with the locating pin 114 extending out of locating pin receiver 112 of the first rail portion end 108 of the first rail portion 106A. When fully assembled, the locating pin 114 extends so that approximately forty percent (40%) of the locating pin 114 is inserted into and disposed in an interference fit within the end cover receivers 46 formed in the dry end cover 34.

Assembly of the datum rail 30 with the wet end cover 32 is proceeds in a manner substantially similar to the assembly described herein with respect to the dry end cover 34. Accordingly, during assembly of the second, third, or greater rail portion 106B, 106C, etc, with the dry end cover 34 of the fuel cell assembly 20, a locating pin 114 is first inserted into the locating pin receiver 112 formed in the second rail portion end 110 of the second, third, or greater rail portion 106C. The locating pin 114 is inserted in a spring-loaded interference fit so that approximately sixty percent (60%) of the locating pin 114 is inserted into and disposed within the locating pin receiver 112 formed in the second rail portion end 110 of the second, third, or greater rail portion 106C. The end cover receivers 46 in the wet end cover 32 further include locating pin receivers. The second rail portion end 110 is aligned with and assembled so that the end cover receivers 46 formed in the wet end cover 32 accurately and precisely engage into an interference fit with the locating pin 114 extending out of locating pin receiver 112 of the second rail portion end 110 of the second, third, or greater rail portion 106C. When fully assembled, the locating pin 114 extends so that approximately forty percent (40%) of the locating pin 114 is inserted into and disposed in an interference fit within the end cover receivers 46 formed in the wet end cover 32.

By disposing only approximately 40% of the locating pin 114 in the end cover receivers 46 formed in the wet and dry end covers 32, 34, the fuel cell stack 22 may be more easily disassembled for servicing. That is, if a BPP 24 or component thereon is damaged during use, the datum rail 30 may be removed from or disassembled from the wet and/or dry end covers 32, 34 and BPPs 24 unstacked therefrom until a serviceable part of the fuel cell stack 22 is reached. Likewise, if a sub-gasket 26, electrical contact, or the like on either a BPP 24 or the wet and/or dry end covers 32, 34 requires servicing, the datum rails 30 may be removed from the wet and/or dry end covers 32, 34 and the appropriate part serviced.

Assembly of first and second rail portions 106A, 106B is similar to that described above, but differs in extent. That is, during assembly of a first rail portion 106A with a second rail portion 106B, a locating pin 114 is first inserted into the locating pin receiver 112 formed in the second rail portion end 110 of the first rail portion 106A. However, rather than extending for an unequal distance into the first and second rail portions 106A, 106B, the locating pin 114 is inserted in a spring-loaded interference fit so that approximately fifty percent (50%) of the locating pin 114 is inserted into and disposed in an interference fit within each of the locating pin receivers 112 formed in each of the second rail portion end 110 of the first rail portion 106A and the first rail portion end 108 of the second rail portion 106B. Thus, the second rail portion 106B is subsequently aligned with and assembled so that the locating pin receiver 112 formed in the first rail portion end 108 of the second rail portion 106B may accurately and precisely engage into an interference fit with the locating pin 114 extending out of the first rail portion 106A.

As shown in the non-limiting example depicted in FIGS. 4B and 4C, the locating pin 114 has a coil or coil-spring-shaped cross-section. The coil or coil-spring-shaped cross-section of the locating pin 114 allows a first cross-sectional diameter 122A of the locating pin 114 to be compressed or decreased before insertion into the datum rail portions 106, and once inserted into the datum rail portions 106, the locating pin 114 expands to a second cross-sectional diameter 122B larger than the first cross-sectional diameter 122A, thereby ensuring a tight interference fit between the locating pin 114 and the locating pin receivers 112.

As shown in FIG. 4C, the locating pin 114 has a substantially peg, bar, or cylindrical solid longitudinal form in plan view. The peg, bar, or cylindrical solid form of the locating pin 114 has tapered or rounded end portions 124. The tapered or rounded end portions 124 extend for a centering portion 126 of the length 128 of the locating pin 114. The centering portion 126 allows for accurate assembly of the locating pin 114 into the locating pin receivers 112 by centering the locating pin 114 in each of the locating pin receivers 112 and allowing the locating pin 114 to be accurately centered within and inserted into the locating pin receivers 112. In several aspects, the terminal ends 130 of the centering portion 126 have terminal end diameters 132 substantially smaller than locating pin receiver diameters 134, and smaller than either the first or the second cross-sectional diameters 122A, 122B of the full locating pin 114. In several aspects, the locating pin receivers 112 in each of the first and second rail portions 106A, 106B and the end cover receivers 46 extend for axial distances 136A, 136B greater than insertion depths 138A, 138B of the locating pin 114 in each of the locating pin receivers 112 formed within the first and second rail portions 106A, 106B.

In some more specific, but non-limiting examples, the locating pins 114 are extend for a total length 128 of approximately twenty-four millimeters (24 mm)+/−0.5 millimeters, and in may have an expanded diameter of approximately 5.2-5.5 millimeters, where the locating pin receiver diameters 134 and the end cover receiver 46 diameters 140 are between about 5 millimeters and about 5.12 millimeters. The centering portions 126 of the locating pin 114 each extend axially for approximately 1.3 millimeters of the overall length 128 of the locating pin 114.

In several non-limiting examples, each of the locating pin receivers 112 formed in the first rail portion end 108 of the first rail portion 106A may extend for approximately 16+/−0.1 millimeters, while the locating pin 114 is inserted only 15+/−0.25 millimeters therein. Likewise, the end cover receivers 46 formed in each of the wet and dry end covers 32, 34 extend for approximately 10+/−0.1 millimeters, whereas the locating pin 114 is inserted only 9+/−0.25 millimeters therein. By contrast, the insertion depths 138A, 138B of the locating pin 114 in each of the locating pin receivers 112 formed within the first and second rail portions 106A, 106B (and any additional rail portions 106C) are equal to one another, and extend for approximately 12+/−0.25 millimeters while the locating pin receivers 112 in each of the first, second, third, and any additional rail portions 106A, 106B, 106C extend for approximately 13+/−0.1 millimeters.

While the locating pin receivers 112 and the end cover receivers 46 have been depicted as having substantially cylindrical shapes, it should be appreciated that other shapes of locating pin receivers 112 and end cover receivers 46 may be used without departing from the scope or intent of the present disclosure. Likewise, while the locating pins 114 have been shown and described herein as having substantially cylindrical shapes, but having coil-shaped cross-sectional shapes, other types of locating pins 114 may be used without departing from the scope or intent of the present disclosure. In several aspects, the locating pins 114 may be solid dowel pins, or other forms of rigid dowel or locating pins 114 capable of providing accurate and precise interference fit with the locating pin receivers 112 and end cover receivers 46. The locating pins 114 are made from materials that provide the necessary structural qualities described above with respect to the datum rail 30 as a whole. In a non-limiting example, the locating pins 114 are formed of an austenitic stainless-steel compatible with aluminum wet and dry end covers 32, 34, and with plastic datum rail 30 or datum rail 30 cover, and datum rail 30 extensions which may be formed of steel.

A multi-piece datum rail 30 of the present disclosure offers several advantages. These include providing for reduced deviation in dimensions of datum rails 30 due to the shortened component part lengths of the datum rail portions 106 by comparison with a solid non-modular datum rail 30, as well as assuring profile tolerances for the datum rail portions 106 and datum rail 30 when fully assembled. Advantages further include simplified manufacturing and elimination of undesired plastic machining processes, increasing the ability of suppliers to implement pultrusion processes to achieve superior quality datum rails 30, and simplifying the assembly of fuel cell stacks that utilize a datum 30 rail that electrically insulates the BPPs 24 from shorting to metal casings of the fuel cell 20 under normal operations and during and after exposure to impacts and high acceleration loads while providing simplified assembly, maintaining tight tolerances, and providing sufficient structural rigidity to ensure that the BPPs 24, CEA and sub gaskets 26 all maintain correct cell alignment, without increasing overall fuel cell complexity, and providing a modular and portable solution for fuel cell stack 22 assembly in a variety of scenarios

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A fuel cell system, comprising:
a first end cover;
a second end cover;
two or more linear beam-like datum rails extending from the first end cover to the second end cover and engaging in interference fit with the first end cover and with the second end cover; and
at least one bipolar plate (BPP), the at least one bipolar plate having locating features formed therein, the locating features sized and shaped to enter into sliding engagement with the two or more linear beam-like datum rails, wherein the two or more beam-like datum rails align the at least one bipolar plate with corresponding electrical, fluid, and mechanical features formed in the first end cover and the second end cover; and wherein
each of the two or more datum rails comprises: two or more modular datum rail portions, each of the two or more modular datum rail portions extends from a first rail portion end to a second rail portion end, wherein a plurality of locating pin receivers is formed axially in each of the first and second rail portion ends, wherein a plurality of locating pins are disposed within the plurality of locating pin receivers, and wherein each subsequent rail portion is connected to at least one other rail portion via the plurality of locating pins, and wherein at least one rail portion is connected to the first end cover via locating pins and at least one rail other rail portion is connected to the second end cover and to the datum rail portion connected to the first end cover via locating pins.

2. The fuel cell system of claim 1, wherein each of the plurality of locating pins is formed of austenitic steel and expandable from a first diameter to a second diameter larger than the first;
each of the plurality of locating pins has a substantially cylindrical overall shape; and
the locating pins having a centering portion at terminal ends of the substantially cylindrical overall shape, wherein the centering portion tapers to a diameter smaller than a diameter of the locating pin receivers.

3. The fuel cell system of claim 2, wherein the first diameter is smaller than a diameter of the locating pin receivers, and wherein the second diameter is greater than the diameter of the locating pin receivers, and wherein upon insertion into the locating pin receivers, each of the plurality of locating pins engages in an interference fit with the locating pin receivers.

4. The fuel cell system of claim 2, wherein approximately fifty percent (50%) of each of the plurality of locating pins that attaches one of the datum rail portions to another of the datum rail portions is disposed in each of the datum rail portions.

5. The fuel cell system of claim 4, wherein approximately sixty percent (60%) of each of the plurality of locating pins that attaches one of the datum rail portions to the first end cover or to the second end cover is disposed in the datum rail portion, whereas approximately forty percent (40%) of the locating pin is disposed within end cover receivers formed in the first and second end covers.

6. The fuel cell system of claim 5, wherein the locating pins extend for at total length of approximately twenty-four millimeters, and wherein the locating pins are inserted approximately twelve millimeters into locating pin receivers formed in datum rail portions connected to other rail portions, wherein the locating pin receivers extend for approximately thirteen millimeters in datum rail portions connected to other rail portions.

7. The fuel cell system of claim 5, wherein the locating pins extend for at total length of approximately twenty-four millimeters, and wherein the locating pins are inserted approximately fifteen millimeters into locating pin receivers formed in datum rail portions connected to the first or second end covers; and
wherein the locating pins are inserted approximately nine millimeters into the end cover receivers; and
wherein the locating pin receivers extend for approximately sixteen millimeters in datum rail portions connected the first or second end covers and the end cover receivers extend for approximately ten millimeters.

8. The fuel cell system of claim 1, wherein the datum rail portions have a substantially C-shaped or U-shaped cross-sectional profile that is consistent over an entire length of the datum rail portions, and over an entire length of the datum rail, and wherein locating features of each BPP define C-shaped or U-shaped axial openings located circumferentially about each BPP to receive and enter into close axial sliding engagement with the substantially C-shaped or U-shaped cross-sectional datum rail portions.

9. The fuel cell system of claim 1, wherein each of the datum rail portions are pultrusion formed of material having a flexural modulus of at least 10 Gpa, tensile strength in all directions of at least 280 Mpa, and volume resistivity of greater than or equal to 1.00e+14 ohm-cm.

10. The fuel cell system of claim 1, wherein each of the two or more linear beam-like datum rails has:
a tensile-axial force capability in a Y-direction of at least 46.5 kN;
a transverse force capability in a X-direction of at least 46.5 kN; and
a transverse force capability in a Z-direction of at least 46.5 kN.

11. The fuel cell system of claim 1, wherein the first end cover is a dry end cover and the second end cover is a wet end cover, wherein the wet end cover has fluid passageways formed therethrough, wherein the fluid passageways are in fluid communication with one or more BPP of a stack of BPPs disposed between the first end cover and the second end cover.

12. A fuel cell system, comprising:
a wet end cover;
a dry end cover;
a plurality of rigid, linear, beam-like datum rails extending from the wet end cover to the dry end cover and engaging in interference fit with the wet end cover and the dry end cover, the datum rails having substantially c-shaped or u-shaped cross-sectional profiles that are consistent over an entire length of the datum rails;
a plurality of bipolar plates (BPPs) sandwiched between the wet end cover and the dry end cover, each of the plurality of BPPs having locating features formed therein, the locating features sized and shaped to enter into sliding engagement with plurality of datum rails such that the plurality of datum rails align the plurality of BPPs with corresponding electrical, fluid, and mechanical features of neighboring BPPs and with the wet end cover and the dry end cover; and wherein
each of the plurality of datum rails comprises: a plurality of modular datum rail portions, each extending from a first rail portion end to a second rail portion end;
a plurality of locating pin receivers is formed axially in each of the first and second rail portion ends; and a plurality of locating pins are disposed within the plurality of locating pin receivers.

13. The fuel cell system of claim 12, wherein each subsequent rail portion is connected to at least one other rail portion via the plurality of locating pins, and wherein at least one rail portion is connected to the wet end cover via locating pins and at least one other rail portion is connected to the dry end cover via locating pins; and wherein at least one rail portion connects the datum rail portion connected to the wet end cover to the datum rail portion connected to the dry end cover via locating pins.

14. The fuel cell system of claim 12, wherein each of the plurality of locating pins is formed of austenitic steel and expandable from a first diameter to a second diameter larger than the first;
each of the plurality of locating pins has a substantially cylindrical overall shape; and
the locating pins having a centering portion at terminal ends of the substantially cylindrical overall shape, wherein the centering portion tapers to a diameter smaller than a diameter of the locating pin receivers, wherein the first diameter is smaller than a diameter of the locating pin receivers, and wherein the second diameter is greater than the diameter of the locating pin receivers, and wherein upon insertion into the locating pin receivers, each of the plurality of locating pins engages in an interference fit with the locating pin receivers.

15. The fuel cell system of claim 14, wherein approximately fifty percent (50%) of each of the plurality of locating pins that attaches one of the datum rail portions to another of the datum rail portions is disposed in each of the datum rail portions; and
wherein approximately sixty percent (60%) of each of the plurality of locating pins that attaches one of the datum rail portions to the wet end cover or to the dry end cover is disposed in the datum rail portion, whereas approximately forty percent (40%) of the locating pin is disposed within end cover receivers formed in the wet and dry end covers.

16. The fuel cell system of claim 15, wherein the locating pins extend for at total length of approximately twenty-four millimeters, and wherein the locating pins are inserted approximately twelve millimeters into locating pin receivers formed in datum rail portions connected to other rail portions, wherein the locating pin receivers extend for approximately thirteen millimeters in datum rail portions connected to other rail portions;
wherein the locating pins are inserted approximately fifteen millimeters into locating pin receivers formed in datum rail portions connected to the wet or dry end covers;
wherein the locating pins are inserted approximately nine millimeters into the end cover receivers; and
wherein the locating pin receivers extend for approximately sixteen millimeters in datum rail portions connected the wet or dry end covers and the end cover receivers extend for approximately ten millimeters.

17. The fuel cell system of claim 12, wherein locating features of each of the plurality of BPPs define C-shaped or U-shaped axial openings located circumferentially about each of the plurality of BPPs to receive and enter into close axial sliding engagement with the substantially C-shaped or U-shaped cross-sectional datum rail portions.

18. The fuel cell system of claim 12, wherein each of the datum rail portions are pultrusion formed of material having a flexural modulus of at least 10 Gpa, tensile strength in all directions of at least 280 Mpa, and volume resistivity of greater than or equal to 1.00e+14 ohm-cm.

19. The fuel cell system of claim 12, wherein each of the plurality of datum rails has:
a tensile-axial force capability in a Y-direction of at least 46.5 kN;
a transverse force capability in a X-direction of at least 46.5 kN; and
a transverse force capability in a Z-direction of at least 46.5 kN.

20. A vehicle having a fuel cell system, the fuel cell system comprising:
a wet end cover;
a dry end cover;
a plurality of rigid, linear, beam-like datum rails extending from the wet end cover to the dry end cover and engaging in interference fit with the wet end cover and the dry end cover, the datum rails having substantially c-shaped or u-shaped cross-sectional profiles that are consistent over an entire length of the datum rails;
a plurality of bipolar plates (BPPs) sandwiched between the wet end cover and the dry end cover, each of the plurality of BPPs having locating features formed therein, the locating features sized and shaped to enter into sliding engagement with plurality of datum rails such that the plurality of datum rails align the plurality of BPPs with corresponding electrical, fluid, and mechanical features of neighboring BPPs and with the wet end cover and the dry end cover; and wherein
each of the plurality of datum rails comprises: a plurality of modular datum rail portions, each extending from a first rail portion end to a second rail portion end;
a plurality of locating pin receivers is formed axially in each of the first and second rail portion ends; and a plurality of locating pins are disposed within the plurality of locating pin receivers,
wherein each subsequent rail portion is connected to at least one other rail portion via the plurality of locating pins, and wherein at least one rail portion is connected to the wet end cover via locating pins and at least one other rail portion is connected to the dry end cover via locating pins; and wherein at least one rail portion connects the datum rail portion connected to the wet end cover to the datum rail portion connected to the dry end cover via locating pins,
wherein each of the plurality of locating pins is formed of austenitic steel and expandable from a first diameter to a second diameter larger than the first;
each of the plurality of locating pins has a substantially cylindrical overall shape; and
the locating pins having a centering portion at terminal ends of the substantially cylindrical overall shape, wherein the centering portion tapers to a diameter smaller than a diameter of the locating pin receivers, wherein the first diameter is smaller than a diameter of the locating pin receivers, and wherein the second diameter is greater than the diameter of the locating pin receivers, and wherein upon insertion into the locating pin receivers, each of the plurality of locating pins engages in an interference fit with the locating pin receivers,
wherein approximately fifty percent (50%) of each of the plurality of locating pins that attaches one of the datum rail portions to another of the datum rail portions is disposed in each of the datum rail portions; and
wherein approximately sixty percent (60%) of each of the plurality of locating pins that attaches one of the datum rail portions to the wet end cover or to the dry end cover is disposed in the datum rail portion, whereas approximately forty percent (40%) of the locating pin is disposed within end cover receivers formed in the wet and dry end covers,
wherein the locating pins extend for at total length of approximately twenty-four millimeters, and wherein the locating pins are inserted approximately twelve millimeters into locating pin receivers formed in datum rail portions connected to other rail portions, wherein the locating pin receivers extend for approximately thirteen millimeters in datum rail portions connected to other rail portions;
wherein the locating pins are inserted approximately fifteen millimeters into locating pin receivers formed in datum rail portions connected to the wet or dry end covers;
wherein the locating pins are inserted approximately nine millimeters into the end cover receivers; and
wherein the locating pin receivers extend for approximately sixteen millimeters in datum rail portions connected the wet or dry end covers and the end cover receivers extend for approximately ten millimeters,
wherein locating features of each of the plurality of BPPs define C-shaped or U-shaped axial openings located circumferentially about each of the plurality of BPPs to receive and enter into close axial sliding engagement with the substantially C-shaped or U-shaped cross-sectional datum rail portions,
wherein each of the datum rail portions are pultrusion formed of material having a flexural modulus of at least 10 Gpa, tensile strength in all directions of at least 280 Mpa, and volume resistivity of greater than or equal to 1.00e+14 ohm-cm,
wherein each of the plurality of datum rails has:
a tensile-axial force capabilities in a Y-direction of at least 46.5 kN;
a transverse force capability in a X-direction of at least 46.5 kN; and
a transverse force capability in a Z-direction of at least 46.5 kN.
